(19) United States
(12) Patent Application Publication
(10) Pub. No.: US 2007/0298799 A1
(43) Pub. Date: Dec. 27, 2007

(54) Transmitter, a Cellular Communication System and Method of Transmitting Radio Signals Therefor

(75) Inventors: Davood Molkdar, Eastleigh (GB); Gerard T. Foster, Swindon (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/574,991

(22) PCT Filed: Nov. 18, 2005
(86) PCT No.: PCT/US05/42250

§ 371 Date: Mar. 9, 2007

(30) Foreign Application Priority Data
Dec. 17, 2004 (GB) 0427636.6

(51) Int. Cl. H04Q 7/20

(52) U.S. Cl. 455/436

(57) ABSTRACT

A transmitter (100) for transmitting radio signals to a receiver comprises a data generator (101) which generates a plurality of groups of information data. A radio condition processor (107) determines a radio environment characteristic, such as a propagation channel path loss or an interference level. A subset processor (103) generates a data message by selecting a subset of the plurality of groups of information data in response to the radio environment characteristic. The data message is then transmitted by a transmit unit (107). The invention may provide flexible and efficient discontinuous transmission operation which may be particularly suitable for discontinuous transmission of control data. The invention may for example reduce interference in cellular communication systems.

### FIELD OF THE INVENTION

The invention relates to a transmitter, a cellular communication system and a method of transmitting radio signals therefor and in particular, but not exclusively, system.

### BACKGROUND OF THE INVENTION

In a cellular communication system a geographical region is divided into a number of cells each of which is served by a base station. The base stations are interconnected by a fixed network which can communicate data between the base stations. A mobile station is served via a radio communication link by the base station of the cell within which the mobile station is situated. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

Currently, the most ubiquitous cellular communication system is the 2nd generation communication system known as the Global System for Mobile communication (GSM). GSM uses a technology known as Time Division Multiple Access (TDMA) wherein user separation is achieved by dividing frequency carriers into 8 discrete time slots, which individually can be allocated to a user. A base station may be allocated a single carrier or a multiple of carriers. One carrier is used for a pilot signal which further contains broadcast information. This carrier is used by mobile stations for measuring of the signal level of transmissions from different base stations, and the obtained information is used for determining a suitable serving cell during initial access or handovers. Further description of the GSM TDMA communication system can be found in ‘The GSM System for Mobile Communications’ by Michel Mouly and Marie Bernadette Pautet, Bay Foreign Language Books, 1992, ISBN 2950719007.

Currently, 3rd generation systems are being rolled out to further enhance the communication services provided to mobile users. The most widely adopted 3rd generation communication systems are based on Code Division Multiple Access (CDMA) wherein user separation is obtained by allocating different spreading and scrambling codes to different users on the same carrier frequency. The transmissions are spread by multiplication with the allocated codes thereby causing the signal to be spread over a wide bandwidth. At the receiver, the codes are used to de-spread the received signal thereby regenerating the original signal. Each base station has a code dedicated for a pilot and broadcast signal, and as for GSM this is used for measurements of multiple cells in order to determine a serving cell. An example of a communication system using this principle is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

In a UMTS CDMA communication system, the communication network comprises a core network and a Radio Access Network (RAN). The core network is operable to route data from one part of the RAN to another, as well as interfacing with other communication systems. In addition, it performs many of the operation and management functions of a cellular communication system, such as billing. The RAN is operable to support wireless user equipment over a radio link being part of the air interface. The wireless user equipment may be a mobile station, a communication terminal, a personal digital assistant, a laptop computer, an embedded communication processor or any communication element communicating over the air interface. The RAN comprises the base stations, which in UMTS are known as Node Bs, as well as Radio Network Controllers (RNC) which control the Node Bs and the communication over the air interface.

In addition to user data, the base stations and mobile stations also communicate control data over the air interface. Such control data is e.g. used to support individual services or communications, such as power control data or measurement report data, or is used to support a plurality of ongoing services, such as system signalling and user control plane signalling.

Control data may be transmitted on individual physical channels or may share a physical channel with user data. For example, a logical user data channel and a logical control data channel may be time multiplexed onto the same physical data channel.

In many present services, the user data is non-continuous. For example, voice and Internet browsing services have a highly bursty nature with intervals of high data rate communication mixed with time intervals with low (or no) data rate communication. In order to reduce interference caused by transmissions, it is known to use discontinuous transmission operation wherein a discontinuous transmission mode is entered when no user data is to be transmitted. In the discontinuous mode, a reduced amount of data is transmitted and typically data is transmitted in only a fraction of the time available. For example, for discontinuous transmission in a GSM communication system (known as DTX operation), data is only transmitted in a subset of the time slots available for the communication link and no interference is thus introduced for the majority of time slots when in DTX mode.

However, conventionally, such discontinuous operation is typically a relatively slow process where transmissions are simply discontinued if there is no data to be transmitted. Accordingly, discontinuous operation is used for user data services such as voice services which comprise relatively long pauses in the data. However, such discontinuous operation is not suitable for other types of data such as control data. For example, a cellular communication system typically generates a continuous stream of control data which is communicated over the air interface and which is continuously used to maintain the radio link between a base station and a mobile station. Accordingly, conventional discontinuous operation is typically not applied to control data.

Thus, the control data is transmitted continuously and independently of the data transmissions of the user data. Hence, even when there is no user data to be communicated, the control data is still transmitted thereby being a source of interference even when there is no user data. This additional interference may degrade performance and reduce the capacity of the cellular communication system as a whole.

For example, in a UMTS cellular communication system, the Dedicated Physical Data CHannel (DPDCH) and Dedicated Packet Control CHannel (DPCCH) are time multiplexed on to the same physical channel in the downlink. The transmission of the DPCCH is continuous with a transmit power that is derived by applying a fixed power offset to the DPDCH transmit power. However, in such a system, the transmission of the DPCCH is a continuous source of interference irrespective of whether there is activity on the DPDCH or not. Thus, the conventional approach results in increased interference, reduced performance for other users and a reduced capacity of the communication system as a whole.

Also, discontinuous operation is performed in response to a simple determination of whether there is any data to be transmitted or not. This approach is inflexible and does not allow for an optimisation for the current operating conditions or for an adaptation to dynamic variations in the operating conditions.

Hence, an improved system for transmitting signals would be advantageous and in particular a system allowing increased flexibility, reduced interference, improved performance and/or increased capacity would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a transmitter for transmitting radio signals to a receiver, the transmitter comprising: means for generating a plurality of groups of information data; means for determining a radio environment characteristic; means for generating a data message by selecting a subset of the plurality of groups of information data in response to the radio environment characteristic; and means for transmitting the data message to the receiver.

The invention may provide for improved transmission in a communication system. In particular, the interference caused to other communications may be reduced while achieving acceptable performance of communication from the transmitter by only transmitting a subset of groups when suitable. The invention may e.g. allow an increased number of groups to be included in the data message when the radio environment characteristic indicates that this does not introduce excessive interference. However, if the radio environment characteristic indicates that a high degree of interference will be introduced, a reduced number of groups may e.g. be included.

A more flexible discontinuous operation may be achieved and/or a discontinuous operation adapting to current conditions may be provided. The interference in the communication system may be reduced resulting in improved performance for other communications and an increased capacity of the communication system as a whole.

Each group of the plurality of groups of information data comprises at least some different information data. This information data may be overlapping but no two groups correspond exclusively to the exact same information data. In other words, no two groups comprise fully redundant data and in particular no two groups comprise only data obtained from error coding of the same information data.

The data message may e.g. be a single data packet, may be a semi-continuous data stream, may be a discontinuous data stream or may e.g. be a plurality of data packets.

According to an optional feature of the invention, the radio environment characteristic comprises a channel characteristic of the propagation channel between the transmitter and the receiver. The selection of information data in the data message may be adapted to the current characteristics of the propagation channel used for the transmission. Hence, a flexible discontinuous operation may be applied which matches the current channel conditions.

According to an optional feature of the invention, the channel characteristic comprises a quality characteristic of the propagation channel between the transmitter and the receiver.

The channel characteristic may for example be a path loss, an interference level (and/or noise level) and/or a received signal level at the receiver. The required transmission power for the transmitter may be affected by the propagation channel quality characteristic and the introduced interference may depend on the propagation channel quality characteristic. Flexibly adjusting the discontinuous operation in response to the propagation channel quality characteristic may improve performance. For example, if the channel quality is very high, a very low transmit power is required resulting in negligible interference being introduced. In this case, a large number (or all) of the groups may be included in the data message. However, if the channel quality is very low, a very high transmit power is required resulting in significant interference being introduced. In this case, a small number of the groups may be included in the data message thereby reducing the interference. Thus, the invention may in some embodiments allow an improved and more flexible trade off between introduced interference, and thus performance of other communications, and the amount of data transmitted, and thus the performance of the communication from the transmitter.

According to an optional feature of the invention, the channel characteristic comprises a rate of change characteristic of the propagation channel between the transmitter and the receiver. For example, some of the groups may relate to propagation channel properties and by including these groups in the data message in response to a rate of change characteristic, the update rate of the communication information data may be adjusted to match the propagation channel variations. The invention may in many embodiments allow an improved, dynamic and/or flexible trade off between data communication and interference depending on an importance of the data to be communicated.

According to an optional feature of the invention, the radio environment characteristic comprises an interference characteristic. The interference characteristic may for example be an indication of a combined interference level at the receiver or at other receivers in the communication system. For example, in a cellular communication system, the interference characteristic may be an indication of how highly loaded a cell of the transmitter is or how highly loaded a neighbour cell of the transmitter is. The invention may thus allow an improved trade off between communication of data and reducing interference depending on how critical this interference may be.

In some embodiments the radio environment characteristic comprises a dispersiveness characteristic. This may improve performance in many embodiments.

According to an optional feature of the invention, each of the plurality of groups of information data bits is associated with a different field of the data message. This may allow for a low complexity implementation and efficient performance.

According to an optional feature of the invention, at least some of the plurality of groups of information data comprises user data. The invention may allow an efficient, flexible, dynamic, adaptive and/or high performance discontinuous transmission mode for transmission of user data.

According to an optional feature of the invention, at least some of the plurality of groups of information data comprises control data. The invention may allow an efficient, flexible, dynamic, adaptive and/or high performance discontinuous transmission mode for transmission of control data. In contrast to conventional discontinuous transmission, the invention may allow a flexible approach which is suited for discontinuous transmission of control data.

According to an optional feature of the invention, the means for generating the data message is arranged to include user data in the data message and to select the subset in response to a user data characteristic.

The data message may comprise both control data and user data. The control data and the user data may be operated in discontinuous mode independently of each other. Furthermore, the discontinuous operation of the control data may be in response to a characteristic of the user data.

This may allow an efficient communication in many embodiments and may in particular allow user and control data transmission with reduced interference. It may additionally or alternatively allow the discontinuous transmission operation for control data to be optimised for the current characteristics and requirements of the user data.

According to an optional feature of the invention, the user data characteristic comprises a user data activity characteristic.

The user data activity characteristic may for example be a user data rate indication or a discontinuity indication indicative of a discontinuity state or operation for the user data. For example, if the user data is operated in a normal transmission mode, all groups of control data may be included in the data message. However, if the user data is operated in a discontinuous transmission mode, the control data may also be operated in a discontinuous transmission mode by only a subset of the groups being included in the data message. Thus, the control data operation may be optimised for the current conditions.

According to an optional feature of the invention, the plurality of groups comprises groups belonging to different communication layers. In particular, the plurality of groups may comprise a first subset of groups belonging to a physical layer and a second set of groups belonging to a higher layer.

The different communication layers may be different layers of an Open Standards Institute (OSI) hierarchical model. The higher layer is a higher layer than the physical layer such as a Radio Link Control (RLC) layer or a Medium Access Control (MAC) layer.

The feature allows for an efficient and flexible communication with reduced interference as an increased compression may be obtained by selecting only a subset of groups for more than one communication layer.

According to an optional feature of the invention, the means for generating the data message is operable to independently select groups of the different communication layers.

The invention may provide for an efficient interference reduction by allowing a low complexity discontinuous operation for different layers. The processing and algorithms for each layer may be independent of each other thereby being consistent with a hierarchical layer organisation and facilitating design and implementation. Specifically, the groups of a first layer to be included in the data message may be selected without any knowledge or consideration of which groups of a different layer are selected for inclusion in the data message.

According to an optional feature of the invention, the data message is a data packet comprising nested headers of the different communication layers. This provides for an efficient implementation which is particularly advantageous for selection of groups from different layers.

According to an optional feature of the invention, the means for generating is operable to include a first group if a radio quality indication of the radio environment characteristic is above a threshold and not to include the first group if the radio quality indication is not above the threshold. This may allow a low complexity implementation with advantageous performance.

According to an optional feature of the invention, the means for generating is further operable to select the subset of the plurality of groups of information data in response to a rate of change of the information data.

This may improve performance and may reduce interference while reducing the impact of transmitting less data. For example, if the information data has not changed significantly, the impact of not updating information previously received may be insignificant and therefore the corresponding group may be removed from the data message with negligible consequences.

According to an optional feature of the invention, a rate of change of the information data of a group of the plurality of groups of information data is determined in response to a difference between a current group of information data and a previously transmitted group of information data. This provides for a practical implementation and advantageous performance in many embodiments.

According to an optional feature of the invention, the means for generating is operable to include an indication of a missing group in the data message. This may facilitate implementation in the receiver and provides for an efficient means of communicating information for the receiver to adjust performance to the data which is received. For example, the data message may comprise a flag for each group indicating whether the group is included in the data message or not.

The transmitter may advantageously be comprised in a cellular communication system such as a GSM cellular communication system or a 3^{rd} Generation cellular communication system such as UMTS. The transmitter may in particular be a transmitter of a base station of the cellular communication system.

According to an optional feature of the invention, the cellular communication comprises the receiver and the receiver is operable to determine information data of a group not included in the subset in response to a previously transmitted group of information data.

This provides for a low complexity yet efficient way of determining data that may be used in the absence of a transmission of a group. For example, if a group of channel information data is removed from the data message, the receiver may use the channel information data that was previously transmitted from the transmitter. As long as the channel has not changed significantly, the impact of this may be negligible and/or acceptable.

According to a different aspect of the invention, there is provided a method of transmitting radio signals to a receiver, the method comprising: generating a plurality of groups of information data; determining a radio environment characteristic; generating a data message by selecting a subset of the plurality of groups of information data in response to the radio environment characteristic; and transmitting the data message to the receiver.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a transmitter in accordance with some embodiments of the invention;

FIG. 2 illustrates the structure of a DCH of a UMTS cellular communication system; and

FIG. 3 illustrates a method of transmitting radio signals to a receiver in accordance with some embodiments of the invention.

### DETAILED DESCRIPTION OF EMBODIMENTS OF THE INVENTION

The following description focuses on embodiments of the invention applicable to a cellular communication system and in particular to a GSM cellular communication system. However, it will be appreciated that the invention is not limited to this application but may be applied to many other communication systems.

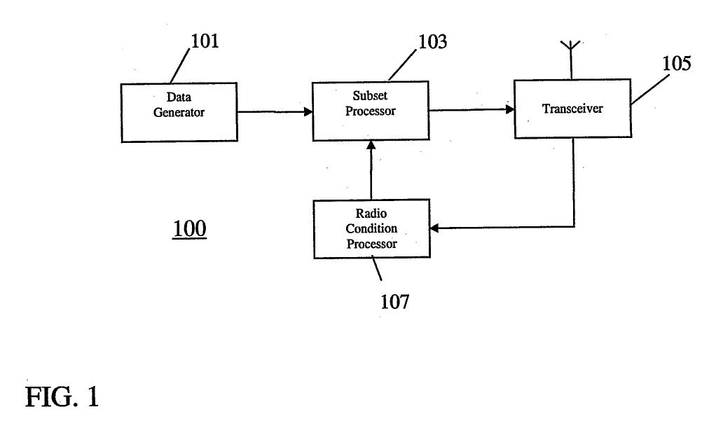

FIG. 1 illustrates a transmitter 100 in accordance with some embodiments of the invention. The transmitter 100 may specifically be a transmitter of a base station of a cellular communication system and the following description will focus on such an embodiment.

The transmitter 100 comprises a data generator 101 which generates a plurality of groups of information data. The data may be received from an external source and/or may be generated by the transmitter 100 itself.

The information data is typically divided into the different groups in response to a suitable criterion relating to the nature or origin of the information. For example, in a cellular communication system, different types of control information may be communicated over the air interface and each of the groups may comprise one particular type of control data. As an example, a downlink DPCCH of a UMTS cellular communication system comprises fields for Transmit Power Commands (TPC), Transmit Format Combination Indicators (TFCIS) and for pilot symbols. In such an embodiment, the first group of information data may comprise the TPC data, a second group the TFCIs and a third group the pilot symbols.

A group of information data may be of any length including being a single bit and may be represented by e.g. error coded channel data bits or by information data bits. Furthermore, different groups may contain overlapping information such that two different groups may comprise bit strings derived from the same information but no two groups will only comprise bit strings derived from the same information data. Thus, specifically, different groups do not exclusively comprise redundant data relating to the same information data. Thus, the groups relate to non-identical information data groups prior to any redundant channel coding or modulation operations.

In the described embodiments, the different groups comprise non-overlapping and separate information data which is to be carried in different fields of a data message. Hence, in the embodiments, each group of information data bits are associated with a different field of the data message.

The data generator 101 is coupled to a subset processor 103 which generates a data message by selecting a subset of the plurality of groups of information data. Specifically, the subset processor 103 may sometimes select all groups thereby filling all fields of the data message whereas at other times only some or no groups are selected thereby creating a data message with some fields empty.

The subset processor 103 is coupled to a transceiver 105 which is operable to perform forward error correction, interleaving, modulation, upconversion and amplification to generate a radio signal for transmitting the data message to a receiver (not shown) as is well known to the person skilled in the art.

In the example of FIG. 1, the transceiver 105 is operable to operate in a discontinuous transmission mode. In particular, the transceiver 105 transmits data at a fixed data rate and accordingly the total time spent on transmitting the data message depends on the data size and thus on which groups are included in the data message.

In some embodiments, the data message may comprise different fields associated with the different groups and the transceiver 105 may transmit in the time intervals of fields for which the group is included but not transmit in time intervals of fields for which the group has not been included.

However, in most embodiments, a given time interval is allocated for transmission of the data message and the transceiver proceeds to transmit all groups selected by the subset processor 103 and then terminates the transmission for the remaining part of this time interval.

For example, in a cellular communication system, a continuous control channel may be divided into discrete frames with a new control message being transmitted in each frame. Conventionally, the transmission of a new control data message may directly follow the previous data message thereby resulting in a continuous channel. However, in accordance with the described example, a control data message having a reduced data size may be transmitted in a time interval that is shorter than a frame and the transmission may be followed by a time interval of no transmission until the next frame begins and a new data message is transmitted.

The transceiver 105 is also coupled to a radio condition processor 107 which determines a radio environment characteristic. The radio environment characteristic may for example be an indication of the current path loss between the transmitter and the receiver and may be determined in response to a receive signal level message received from the receiver.

The radio condition processor 107 is coupled to the subset processor 103 and the subset processor 103 selects the groups to include in the data message in response to the radio environment characteristic.

As a specific example, the subset processor 103 may compare the current path loss to a threshold for each group and if the path loss is below the threshold, the group is included and if the path less is above the threshold, the group is not included.

In this way, if the path loss is below a threshold, a relatively low transmit power is required resulting in a relatively low interference to other communications in the cellular communication system, and accordingly the resource usage and impact of transmitting data is relatively low. In this case the benefits of transmitting a group of data may outweigh the disadvantages of increased interference and the group is accordingly included.

However, if the path loss is above the threshold, a relatively high transmit power is required. This will result in a relatively high interference to other communications in the cellular communication system and accordingly the resource usage and impact of transmitting data is relatively high. In this case the benefits of transmitting a group of data may not outweigh the disadvantages of increased interference and the group is accordingly not included in the data message.

Thus, in such an embodiment, a significantly improved trade off between the advantages and disadvantages of transmitting data may be achieved.

The thresholds for different groups may be different such that as the path loss increases, the fields of the data message are sequentially emptied thereby gradually reducing the interference caused by transmitting the data message. Thus, a very flexible and gradual discontinuous transmission operation may be performed. In some embodiments, a total interference caused by transmitting the data message may be kept relatively constant and the amount of data may be varied in response to the path loss to achieve this relatively constant interference.

Thus, the transmitter of FIG. 1 may allow a very flexible, dynamic, gradual and efficient discontinuous transmission operation. The transmitter allows for individual groups of information data to be included or excluded from transmission depending on the actual interference caused by transmitting them. The discontinuous transmission of the example of FIG. 1 is, in contrast to conventional discontinuous operation, suitable for control data and may allow a low complexity trade off between reducing interference and transmitting control data.

It will be appreciated that many other radio environment characteristics than a path loss may be used.

In many embodiments, a channel characteristic, and in particular a quality characteristic, of the propagation channel between the transmitter and the receiver may be used to select which groups to include. This may provide a good indication of the interference that will be incurred by transmitting a group of information data. For example, benign propagation conditions may allow reliable communication at low transmit power and thus low interference. However, at less benign propagation conditions, the transmit power must be high resulting in a high level of interference.

In some embodiments, the radio environment characteristic may additionally or alternatively relate to characteristics which are not specific to the propagation path between the transmitter and the receiver. For example, the radio environment characteristic may relate to a total interference or noise level at the receiver. If the interference (including noise) level is high, a relatively high transmit power is required resulting in significant interference being introduced.

In some embodiments, the radio environment characteristic does not directly relate to the amount of interference that will result from transmitting data but rather to how critical any additional interference will be. For example, the radio environment characteristic may be indicative of a general load or interference level in the cell. Thus, when a cell is lightly loaded, the general interference level is low and an additional interference can easily be accommodated without any impact. However, for a loading close to the capacity of the cell, any additional interference may significantly degrade performance. Thus, the subset processor 103 may, in an exemplary embodiment, transmit all groups if the loading of the cell is below a given threshold but only transmit a subset if the loading is above this threshold.

In some embodiments the radio environment characteristic may be indicative of a rate of change of the propagation channel between the transmitter and the receiver. For example, some data may be control data related to the channel conditions, such as a power control command. If the propagation is fast changing (for example because the receiver is a fast moving mobile station), groups comprising power control information may always be included whereas if propagation is slowly changing (for example because the receiver is a stationary station), groups comprising power control information may only occasionally be included.

It will be appreciated that the radio environment characteristic may e.g. be determined in response to characteristics or properties measured by the receiver, by the transmitter and/or by a third entity. For example, in low complexity embodiment, the receiver may report a received signal to interference ratio and this may be used directly as the radio environment characteristic.

In the following, specific exemplary embodiments of an application to a downlink Dedicated CHannel (DCH) of a UMTS cellular communication system will be described.

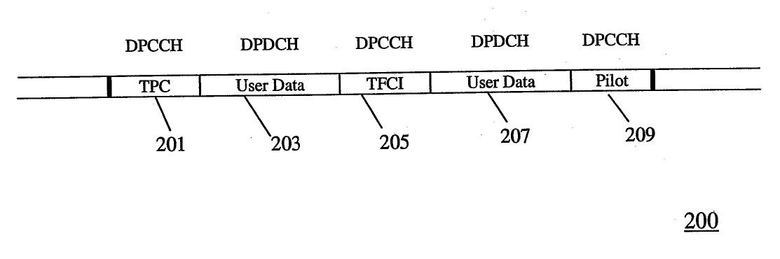

FIG. 2 illustrates the structure of a DCH that may be transmitted by the transmitter 100 of FIG. 1. A DCH comprises a time multiplexed DPCCH and DPDCH. Specifically, a frame 200 of the DCH comprises a first DPCCH field 201 comprising a Transmit Power Command (TPC) followed by a second field 203 comprising DPDCH user data. The second field 203 is followed by a third field 205 which is a DPCCH field comprising a Transmit Format Combination Indication (TFCI). The fourth field 207 of the frame is a DPDCH field comprising user data and the last fifth field 209 is a DPCCH field comprising pilot symbols.

UMTS provides for a discontinuous transmission of the user data fields 203, 207. Specifically, if there is not sufficient user data to fill the entire field, the available data is transmitted and the transmission is then switched off for the remaining interval of the DPDCH field. However, such discontinuous transmission is only performed in response to the amount of data waiting to be transmitted and no discontinuous operation is provided for the control data of the DPCCH. Thus, even if there is no user data to be transmitted, the DCH still introduces interference.

In accordance with some embodiments of the invention, the data generator 101 may generate five groups of information data, each of which corresponds to a specific field of the data message of the frame of the DCH. The subset processor 103 may then select which of these groups to include in the data message in response to the radio environment characteristic.

Thus, for example, if the current propagation channel between the transmitter and the receiver is benign and the loading of the cell is low, the subset processor 103 may include all groups and thus transmit a full DCH frame. However, if the propagation channel is in a fade and/or the loading is high, the subset processor 103 may for example not include the TPC and TFCI groups of data. Thus, a DCH frame data message comprising only user data and the pilot symbols may be transmitted thereby reducing interference.

In some embodiments, the subset processor 103 may select which groups to include in response to a characteristic of the user data. Specifically, the subset processor 103 may select whether to include control data groups in response to the user data activity. As a specific example, the subset processor 103 may always include all data if the user data is not in a discontinuous operation and only allow control data to be omitted from fields if the user data is in a discontinuous transmission mode.

The subset processor 103 may in some embodiments be arranged to select groups for the data message in response to a rate of change of the information data. Thus if the information is fast varying data, the subset processor 103 may include the corresponding group in all data messages whereas if the information is slowly varying data, it may not be included in all data messages.

As a more detailed example, the transmitter may comprise functionality for tracking the variations of the propagation channel between the receiver and the transmitter, for example in response to a receive signal indication received from the receiver. If the channel is fast varying, it may be deemed necessary to operate a fast power control loop in order to track the channel variations and ensure reliable performance. However, if the channel is slowly varying, the generated transmit power controls may only change relatively rarely and a slow power control will be sufficient. In this case, the subset processor 103 may omit the TPC data in, for example, every other DCH frame.

In some embodiments, the rate of change of the information data may be determined without explicitly evaluating the information data. However, in other embodiments, the subset processor 103 may e.g. determine the difference between corresponding groups of subsequent data messages. For example, if a field has a numeric value, the difference between the current numeric value and the numeric value that was last transmitted to the receiver may be determined, and the data may be included only if this difference is above a given level. This may reduce interference by only transmitting data when it is likely to be of sufficient significance at the receiving end.

The receiver may in some embodiments be operable to determine information data of an omitted field in response to a previously transmitted group of information data. In a low complexity embodiment, the receiver may simply use the information from the data message which was last received comprising data in the relevant field. In other embodiments, the receiver may extrapolate data from a plurality of previously received data messages.

It will be appreciated that in some embodiments the groups of information data generated by the data generator 101 comprises groups belonging to different communication layers of a hierarchical model, such as the Open Standards Institute (OSI) hierarchical model.

Specifically, in cellular communication systems many data packets which are transmitted over the air interface comprise a nested arrangement of headers where lower hierarchical layers add a header to data packets received from higher data layers.

In such embodiments, the data generator may generate a first set of groups of data which relate to a first header of a first layer and a second set of groups of data which relate to a second header of a second layer.

The subset processor 103 may in such an embodiment select data for the first header in response to a suitable criterion and may independently select data for the second header in response to another criterion (the two criteria could be the same).

As a specific example, the data generator 101 may receive a data packet that comprises two headers from two different layers. This data packet may be fed to the subset processor 103 which then may select groups of data include in the data packet by removing some data elements of the first header and some data elements of the second header. The resulting data message may then be transmitted.

In some embodiments, the subset processor 103 may include an indication of a missing group in the data message. For example, the subset processor 103 may append a data field comprising one bit for each field of the data message. Each bit of this field may be used as a flag indicating whether the corresponding field comprises data or whether it has been removed. This may provide a practical means of informing the receiver of which data fields are included and may allow the receiver to readily determine the groups of data which are received.

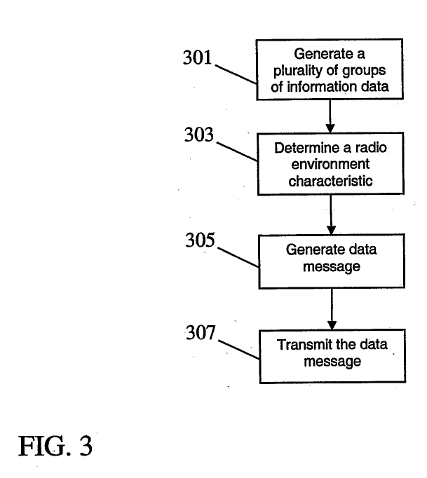

FIG. 3 illustrates a method of transmitting radio signals to a receiver in accordance with some embodiments of the invention. The method may be applicable to the transmitter of FIG. 1.

The method initiates in step 301 wherein a plurality of groups of information data is generated. Specifically, the data generator 101 may generate a plurality of groups as previously described.

Step 301 is followed by step 303 wherein a radio environment characteristic is determined. Specifically, the radio condition processor 107 may determine the radio environment characteristic as previously described.

Step 303 is followed by step 305 wherein a data message is generated by selecting a subset of the plurality of groups of information data in response to the radio environment characteristic. Specifically, the subset processor 103 may select the groups as previously described.

Step 305 is followed by step 307 wherein the data message is transmitted to a receiver. Specifically, the subset processor may pass the data message to the transceiver 105 which then transmits the data message.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. A transmitter for transmitting radio signals to a receiver, the transmitter comprising:
means for generating a plurality of groups of information data;
means for determining a radio environment characteristic;
means for generating a data message by selecting a subset of the plurality of groups of information data in response to the radio environment characteristic; and
means for transmitting the data message to the receiver.

2. The transmitter claimed in claim 1 wherein the radio environment characteristic comprises a channel characteristic of the propagation channel between the transmitter and the receiver, wherein the channel characteristic comprises at least on of; a quality characteristic of the propagation channel between the transmitter and the receiver, a rate of change characteristic of the propagation channel between the transmitter and the receiver, an interference characteristic.

3. The transmitter claimed in claim 1 wherein each of the plurality of groups of information data bits is associated with at least one of; a different field of the data message, user data, control data, and different communication layers.

4. The transmitter claimed in claim 3 wherein the means for generating the data message is arranged to include user data in the data message and to select the subset in response to a user data characteristic.

5. The transmitter claimed in claim 1 wherein the plurality of groups comprises groups belonging to different communication layers, and the means for generating the data message is operable to independently select groups of the different communication layers.

6. The transmitter claimed in claim 5 wherein the data message is a data packet comprising nested headers of the different communication layers.

7. The transmitter claimed in claim 1 wherein the means for generating is operable to include a first group if a radio quality indication of the radio environment characteristic is above a threshold and not to include the first group if the radio quality indication is not above the threshold.

8. The transmitter claimed in claim 1 wherein the means for generating is further operable to select the subset of the plurality of groups of information data in response to a rate of change of the information data determined in response to a difference between a current group of information data and a previously transmitted group of information data.

9. The transmitter claimed in claim 1 wherein the means for generating is operable to include an indication of a missing group in the data message, and wherein the cellular communication comprises the receiver and the receiver is operable to determine information data of a group not included in the subset in response to a previously transmitted group of information data.

10. A method of transmitting radio signals to a receiver, the method comprising:
generating a plurality of groups of information data;
determining a radio environment characteristic;
generating a data message by selecting a subset of the plurality of groups of information data in response to the radio environment characteristic; and
transmitting the data message to the receiver.
